(19) United States
(12) Patent Application Publication
(10) Pub. No.: US 2004/0187606 A1
(43) Pub. Date: Sep. 30, 2004

(54) Torque sensing apparatus for picking up a magnetic flux

(76) Inventors: Thomas Wolfgang Nehl, Shelby Township, MI (US); Joseph Pierre Heremans, Troy, MI (US); Brian K. Fuller, Rochester Hills, MI (US); John R. Smith, Birmingham, MI (US); Malakondaiah Naidu, Troy, MI (US); Avoki M. Omekanda, Rochester, MI (US)

Correspondence Address: SCOTT A. MCBAIN, DELPHI TECHNOLOGIES, INC., Legal Staff, Mail Code: 480-410-202, P.O. Box 5052, Troy, MI, 48007-5052, US

(21) Appl. No.: 10/763,763

(22) Filed: Jan. 23, 2004

Related U.S. Application Data
(63) Continuation-in-part of application No. 10/402,620, filed on Mar. 28, 2003.

(51) Int. Cl. G01L 3/02

(52) U.S. Cl. 73/862.333

(57) ABSTRACT

A torque sensing apparatus for picking up a magnetic flux in response to applying a torque to a shaft is disclosed. A magnetostrictive material is disposed on the surface of the shaft and is magnetically polarized. The apparatus includes a first flux collector and a second flux collector spaced from each other and extending annularly around the shaft. A first fluxgate is connected to the first flux collector at one end and to the second flux collector at the other end with a first excitation coil wound about the first fluxgate. A second fluxgate is connected to the first flux collector at one end and to the second flux collector at the other end with a second excitation coil wound about the second fluxgate. A feedback coil is positioned between the shaft and the flux collectors, the fluxgates, and the excitation coils.

### CROSS-REFERENCE TO RELATED APPLICATIONS

This application is a continuation-in-part of U.S. patent application Ser. No. 10/402,620 filed on Mar. 28, 2003.

### BACKGROUND OF THE INVENTION

1) Field of the Invention

The subject invention relates to torque sensing apparatus and, in particular, an apparatus and method for sensing movement and rotation of a shaft.

2) Description of Related Art

In systems having rotating drive shafts it is sometimes necessary to know the torque and speed of these shafts in order to control the same or other devices associated with the rotatable shafts. Accordingly, it is desirable to sense and measure the torque applied to these items in an accurate, reliable and inexpensive manner. Sensors to measure the torque imposed on rotating shafts, such as but not limited to shafts in vehicles, are used in many applications. For example, it might be desirable to measure the torque on rotating shafts in a vehicle's transmission, or in a vehicle's engine (e.g., the crankshaft), or in a vehicle's steering system for a variety of purposes known in the art.

One application of this type of torque measurement is in electric power steering systems wherein an electric motor is driven in response to the operation and/or manipulation of a vehicle steering wheel. The system then interprets the amount of torque or rotation applied to the steering wheel and its attached shaft in order to translate the information into an appropriate command for an operating means of the steerable wheels of the vehicle.

Prior methods for obtaining torque measurement in such systems were accomplished through the use of contact-type sensors directly attached to the shaft being rotated. For example, one such type of sensor is a “strain gauge” type torque detection apparatus, in which one or more strain gauges are directly attached to the outer peripheral surface of the shaft and the applied torque is measured by detecting a change in resistance, which is caused by applied strain and is measured by a bridge circuit or other well-known means.

Another type of sensor used is a non-contact torque sensor wherein magnetostrictive materials are disposed on rotating shafts and sensors are positioned to detect the presence of an external flux which is the result of a torque being applied to the magnetostrictive material.

Such magnetostrictive materials require an internal magnetic field which is typically produced or provided by either pre-stressing the magnetostrictive material by using applied forces (e.g., compressive or tensile). The magnetic field is circumferential either in a clockwise or counter clockwise direction as a result of a hoop stress. Alternatively, an external magnet or magnets are provided to produce the same or a similar result to the magnetostrictive material.

To this end, magnetostrictive torque sensors have been provided wherein a sensor is positioned in a surrounding relationship with a rotating shaft, with an air gap being established between the sensor and shaft to allow the shaft to rotate without rubbing against the sensor. A magnetic field is generated in the magnetostrictive material by passing a pulse of high-intensity electric current through an electrical conductor located inside the shaft. This results in a pulsed magnetic field that permeates the magnetostrictive material and magnetizes it. The electrical conductor is then removed, and the magnetostrictive material remains magnetized, i.e. it hosts a permanent magnetic field. Applying torque to the shaft changes direction of this magnetic field. A fraction of this field closes a loop through a set of magnetic field sensors located outside the magnetostrictive material.

The output of the magnetic field sensors is an electrical signal that depends on the total magnetic reluctance in the above-described loop. Part of the total magnetic reluctance is established by the air gap, and part is established by the shaft itself. The magnetic field through the magnetic sensors, changes as a function of torque applied to the shaft. Thus, changes in the output of the magnetic sensors can be correlated to the torque experienced by the shaft. Magnetic field sensors are typically Hall sensors.

As understood herein, the air gap, heretofore necessary to permit relative motion between the shaft and sensor, nonetheless undesirably reduces the sensitivity of conventional magnetostrictive torque sensors. As further understood herein, it is possible to minimize the air gap between a shaft and a magnetostrictive torque sensor, thereby increasing the sensitivity of the sensor vis-a-vis conventional sensors. Moreover, the subject invention recognizes that a phenomenon known in the art as “shaft run-out” can adversely effect conventional magnetostrictive torque sensors, and that a system can be provided that is relatively immune to the effects of shaft run-out.

Accordingly, the related art assemblies and methods are characterized by one or more inadequacies. Therefore, it would be advantageous to provide a torque sensing apparatus that senses and measures an applied torque in an accurate, reliable, and inexpensive manner. Further, it would be advantageous to provide the torque sensing apparatus substantially free of outside magnetic interference.

### BRIEF SUMMARY OF THE INVENTION

The subject invention provides a torque sensing apparatus for picking up a magnetic flux flowing from edges of a magnetostrictive material disposed on a shaft. The apparatus includes a first flux collector and a second flux collector spaced from each other and extending annularly around the shaft to define a gap therebetween. A first fluxgate is connected to the first flux collector at one end and to the second flux collector at the other end. A first excitation coil is wound about the first fluxgate and a feedback coil is positioned in the gap such that the feedback coil is wound within the flux collectors, the first fluxgate, and the excitation coil.

The subject invention overcomes the inadequacies that characterize the related art assemblies and methods. Specifically, the subject invention provides an accurate, reliable, and inexpensive apparatus for sensing torque that is substantially free from outside magnetic interference. Since the feedback coil is wound within the flux collectors, the first fluxgate, and the excitation coil, the subject invention minimizes interaction of flux from the feedback coil interacting with any shields resulting in a more stable flux measurement.

### BRIEF DESCRIPTION OF THE SEVERAL VIEWS OF THE DRAWING

Other advantages of the subject invention will be readily appreciated as the same becomes better understood by reference to the following detailed description when considered in connection with the accompanying drawings wherein:

FIG. 1 is a perspective view of a torque sensing apparatus of the subject invention disposed about a shaft having a magnetostrictive material;

FIG. 2 is a cross-sectional side view of the torque sensing apparatus having a shield positioned adjacent the apparatus;

FIG. 3 is a perspective view of a fluxgate having a coil positioned along the fluxgate;

FIG. 4A is a graph of the BH curve of the fluxgate of the torque sensing apparatus of the subject invention with no torque applied to the shaft;

FIG. 4B is a graph of the BH curve of the fluxgate of the torque sensing apparatus of the subject invention with torque applied to the shaft, but with no current in the feedback coil;

FIG. 5 is a graphical illustration of the time dependence of the voltage across the excitation coils and the feedback coil for no torque applied to the shaft;

FIG. 6 is a graphical illustration modeling the theoretical time dependence of the voltage across the excitation coils and the feedback coil for torque applied to the shaft, but with no current in the feedback coil;

FIG. 7 is a graphical illustration modeling an experimentally measured voltage waveform on the feedback coil when a sinusoidal voltage is applied to the excitation coils in the presence of a torque flux, but with no current in the feedback coil;

FIG. 8 is a graphical illustration of a measured voltage waveform by the feedback coil when a sinusoidal voltage is applied to the excitation coils and a direct current is applied to the feedback coil to cancel out the torque flux;

FIG. 9 is a graphical illustration of a direct current component of an output voltage on the feedback coil versus an applied torque; and

FIG. 10 is a circuit diagram according to the subject invention.

### DETAILED DESCRIPTION OF THE INVENTION

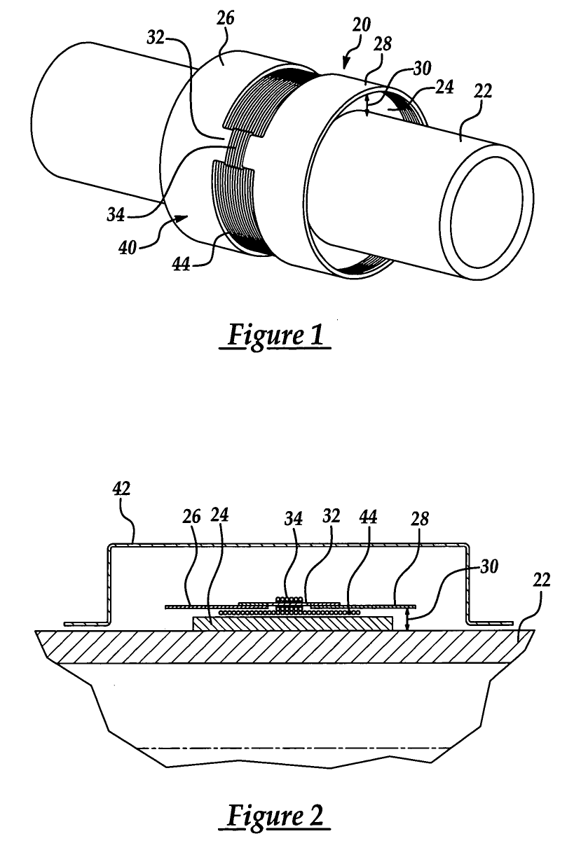

Referring to the Figures, wherein like numerals indicate like or corresponding parts throughout the several views, a torque sensing apparatus for picking up a magnetic flux is shown generally at 20 in FIG. 1. The apparatus 20 includes a torque-subjected member illustrated in the form of a cylindrical shaft 22. However, the subject invention is not intended to be limited to the specific configurations illustrated in FIG. 1. The shaft 22 preferably comprises a non-magnetic material, such as a stainless steel or aluminum. As shown, the apparatus 20 is disposed in a surrounding relationship with the shaft 22 to sense the torque imposed on the shaft 22. In one exemplary embodiment, the shaft 22 is a rotating shaft within a vehicle. For instance, the shaft 22 can be a steering column shaft, engine shaft, or transmission shaft, although it is to be appreciated that the principles set forth herein apply equally to other vehicular and non-vehicular rotating shafts.

A magnetostrictive material 24 is disposed on the surface of the shaft 22. The magnetostrictive material 24 is coated on or applied to the shaft 22 in a manner that will produce a flux signal when the torque is applied to the shaft 22. The same signal is collected by the torque sensing apparatus 20 for measuring the torque applied to the shaft 22. An example of the magnetostrictive material 24 is of the type disclosed in U.S. Pat. No. 6,645,039, the contents of which are incorporated herein by reference thereto. Of course, other types of magnetostrictive materials 24 are contemplated to be used in accordance with the subject invention. The magnetostrictive material 24 may be applied by spraying techniques such as, but not limited to, thermal spraying or kinetic spraying. The magnetostrictive material 24 typically includes, but is not limited to, magnetostrictive particles selected from one of iron, iron alloys, ingot rare earth composites, nickel, and terfenol and magnetic particles with coercivity selected from AlNiCo₅ magnets and melt spun terfenol.

The magnetostrictive material 24 is magnetically polarized to have a circumferential moment in a first direction, such as in clockwise or counterclockwise direction about the shaft 22. Of course, the magnetostrictive material 24 may be magnetically polarized in an opposite direction as will be appreciated by those skilled in the art. Upon receipt of an applied torque, a longitudinal, or axial, magnetic flux or torque flux leaves the magnetostrictive material 24. This flux is proportional to the torque that will be picked up by the torque sensing apparatus 20. In other words, the torque flux flows from edges of the magnetostrictive material 24.

Referring now in particular to FIGS. 1 and 2, a first flux collector 26 and a second flux collector 28 are shown spaced from each other. The first and second flux collectors 26, 28 extend annularly around the shaft 22. A gap 30 is defined between the shaft 22 and the first and second flux collectors 26, 28. The first and second flux collectors 26, 28 are constructed out of a high-permeable material such as metalglass, permalloy, mumetal, or other materials having equivalent characteristics. As will be discussed herein, the configuration of the first and the second flux collectors 26, 28 allow the flux collectors to pick up torque flux signals anywhere along the periphery of magnetostrictive material 24.

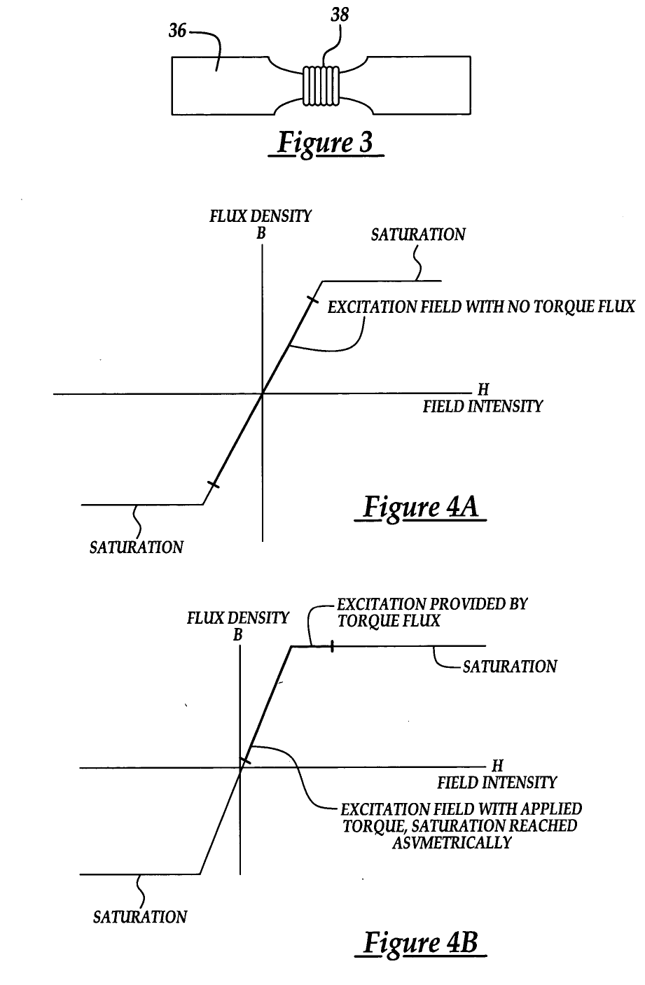

A first fluxgate 32 is connected to the first flux collector 26 at one end and to the second flux collector 28 at the other end. The first fluxgate 32 has a first excitation coil 34 wound about the first fluxgate 32. Preferably, the apparatus 20 includes a second fluxgate 36 connected to the first flux collector 26 at one end and to the second flux collector 28 at the other end, opposite the first fluxgate 32 in FIG. 1. FIG. 3 illustrates one embodiment of the second fluxgate 36. Preferably, the first and the second fluxgate 32, 36 are similarly shaped with the most preferred shape shown in FIG. 3. A second excitation coil 38 is wound about the second fluxgate 36. Preferably, the first and second excitation coils 34, 38 are connected in series, as will be described in more detail below. Preferably, the first and second flux collectors 26, 28 and the first and second fluxgates 32, 36 are constructed of a high-permeable material. Most preferably, the first and second excitation coils 34, 38 are formed from copper. It is to be appreciated that either the first and second excitation coils 34, 38 may also be used to detect a signal, which may be referred to as pick-up coils by those skilled in the art.

In the most preferred embodiment, the first and second flux collectors 26, 28 and the first and second fluxgates 32, 36, with the respective excitation coils 34, 38, are integrally formed as a sleeve unit 40. The shaft 22 and the magnetostrictive material 24 are freely rotatable inside the sleeve unite 40. As will be described herein, the sleeve unit 40 is adapted to measure the torque flux of the shaft 22. The sleeve unit 40 is constructed of a non-conductive material such as plastic, nylon or polymer of equivalent properties, which is lightweight and easily molded or manufactured. In addition, the sleeve unit 40 may be secured to a structure (not shown) that is stationary with respect to the shaft 22.

Further, a shield 42 is positioned about the sleeve unit 40, shown in FIG. 2. The shield 42 prevents the apparatus 20 from being affected by external magnetic fields, such as the Earth's magnetic field or fields present from other electronic devices, such as within a vehicle. This allows the apparatus 20 to be substantially free of outside magnetic interference. However, it is to be appreciated that the apparatus 20 still functions without the shield 42 and that the shield 42 may be formed of any structure, such as an entire engine compartment of the vehicle and still prevent magnetic interference.

The subject invention also includes a feedback coil 44 positioned in the gap 30 between the sleeve unit 40 and the shaft 22. It is to be appreciated that the feedback coil 44 may be formed integrally with the sleeve unit 40, in which case, the feedback coil 44 is between the shaft 22 and the flux collectors 26, 28, the fluxgates 32, 36, and the excitation coils 34, 38. By positioning the feedback coil 44 within the gap, any flux generated in the feedback coil 44 is prevented from interacting with outside interference, such as the shield 42 or vehicle. The flux collectors 26, 28, the fluxgates 32, 36, and the excitation coils 34, 38 act to limit the amount of flux leakage from the feedback 44 to these outside interferences. When the feedback coil 44 is wound about and on the outside of the sleeve unit 40, then the flux generated by the feedback coil 44 interacts with the shield 42 which effects the measurement of the torque being applied to the shaft 22. Therefore, the positioning the feedback coil 44 between the sleeve unit 40 and the shaft 22 is important to accurately detect and measure the torque being applied.

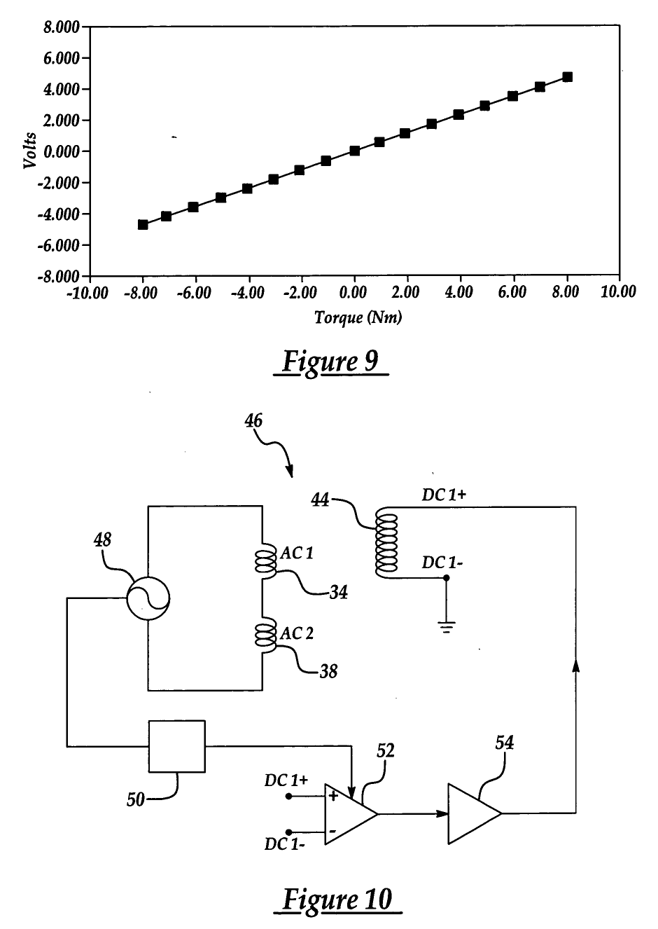

Referring to FIG. 10, a detection circuit 46 is shown for determining a torque applied to the shaft 22. The detection circuit 46 includes a voltage source 48 for applying a voltage to the first and second excitation coils 34, 38 at a first frequency. A frequency doubler 50 may be used for doubling the first frequency to a second frequency and for producing an output signal relating to the voltage sensed across the feedback coil 44. The detection circuit 46 further includes a lock-in amplifier 52 for receiving signals related to a second harmonic voltage waveform on the feedback coil 44 and for receiving a reference signal from the frequency doubler 50. The output signal is received by a voltage to current converter 54 configured to receive the output voltage from the lock-in amplifier 52 and convert it to a current. The current in the feedback loop is driven to zero out the total flux that is applied to the first fluxgate 32 and the second fluxgate 36.

The feedback coil 44 is configured to receive magnetic flux from the shaft 22 with the magnetostrictive coating 22 and also to generate a feedback flux proportional to the current put out by the converter 54. Thus, the apparatus 20 is capable of maintaining the fluxgate material out of magnetic saturation wherein an applied torque will create a torque flux that will be picked up by the apparatus 20. When the fluxgate material is out of saturation, there is no 2^{nd} harmonic waveform (current or voltage). This is the case, e.g., when no torque flux is generated by the shaft 22. When torque is applied to the shaft 22, there is a torque flux and a second harmonic signal appears at the output of the lock-in amplifier 52. The converter 54 then sends a current which creates a feedback flux. When the feedback flux exactly compensates the torque flux, the second harmonic signal of the output of the lock-in amplifier 52 is zero, and there is equilibrium. Thus, the subject invention uses the 2^{nd} harmonic waveform (current or voltage) to provide a signal that is used to provide a nullifying current to the feedback coil 44.

As discussed above, when the torque is applied to the shaft 22, the longitudinal magnetic torque flux leaves the coating of magnetostrictive material 24, and the sleeve unit 40 provides this flux with a return path. The produced torque flux, if existing, is picked up by the first flux collector 26, passes through the first and second fluxgates 32, 36 and the second flux collector 28 to the other side of the magnetostrictive material 24. The feedback flux subtracts from the torque flux produced by the feedback coil 44. The current from the converter 54 that flows through the feedback coil 44 is then as a measurement of the applied torque.

Referring to FIGS. 4A, a flux density (B) versus a magnetization force, or field intensity (H) curve for the fluxgate 36 is illustrated without torque being applied to the shaft 22. The material used to form the fluxgates 32, 36 reaches magnetic saturation when subject to a strong enough magnetic field. Saturation is illustrated as a plateau in FIGS. 4A and 4B. The excitation current through the coils 34, 38 results in an excitation field as shown in FIGS. 4A and 4B.

Referring to FIG. 4B, a flux density (B) versus a magnetization force, or field intensity (H) curve for the sleeve unit 40 is illustrated with torque being applied to the shaft 22. The application of torque to the shaft 22 results in the torque flux which adds to the excitation field of FIG. 4A and shifts the field so as to cause magnetic saturation of the fluxgates 32, 36. The saturation is achieved in one direction when the torque is applied in one direction and in the opposite direction when the torque is applied in the opposite direction.

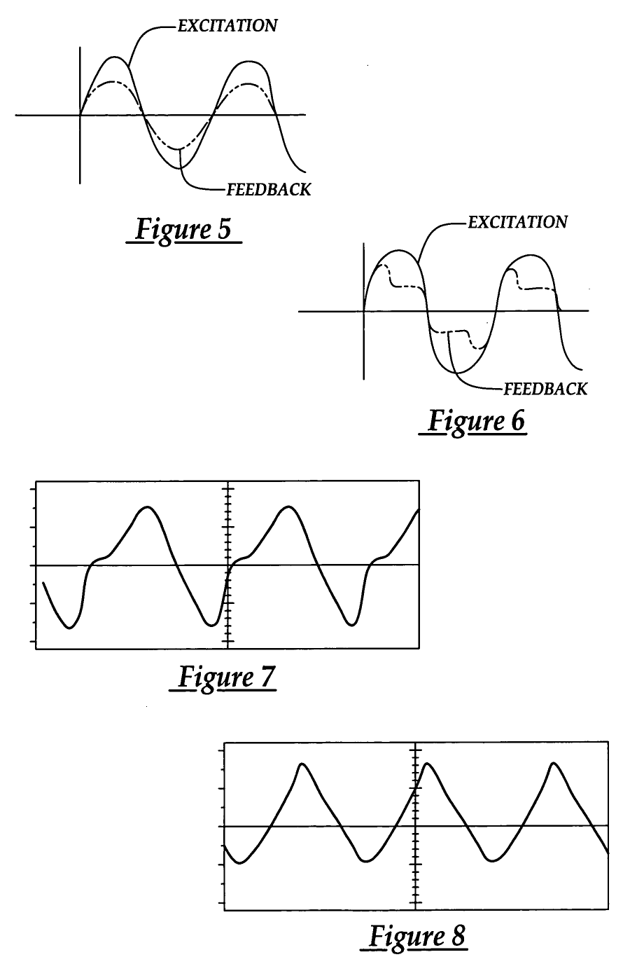

FIG. 5 illustrates the time dependence of the voltage across the excitation coils and feedback coil 44 without torque being applied to the shaft 22. The first and the second excitation coils 34, 38 are connected in series and are excited by a high frequency sinusoidal voltage to generate magnetic flux. The sinusoidal voltage and the frequency are adjusted such that the passing flux through the first and second fluxgates 32, 36 and the first and second flux collectors 26, 28 does not cause saturation without torque flux. The sinusoidal voltage and frequency are adjusted such that the first and second flux gates are just below the saturation limit, as discussed above. FIG. 6 illustrates the time dependence of the voltage across the excitation coils and feedback coil 44 with torque being applied, but when the converter 54 is disconnected.

In operation, torque is applied to the shaft 22 in either a clockwise direction or a counterclockwise direction. Torque can be applied while the shaft 22 rotates freely inside the sleeve unit 40. When the torque is applied, the torque flux generated by the material 24 is sensed by the flux collectors 26, 28 and passed through the fluxgates 32, 36.

In the coil arrangement of FIG. 1, the induced voltage in the feedback coil 44 contains a 2^{nd} harmonic component upon application of the torque to the shaft 22, as illustrated in FIGS. 6 and 7. This 2^{nd} harmonic voltage is extracted by a means of the lock-in amplifier 52 and rectified and fed, as current, to the feedback coil 44 via the voltage to current converter 54 to nullify the 2^{nd} harmonic component. This current through the feedback coil 44 is proportional to the torque applied to the shaft 22.

In addition, and due to the circular configuration of the flux collectors 26, 28, the apparatus 20 is capable of integrating the magnetic flux about the entire periphery of the magnetostrictive material 24. Accordingly, the torque moment is measured about the entire periphery of the magnetostrictive material 24 by integrating along the circumference at either end of the magnetostrictive material 24. This allows the apparatus 20 to measure the torque moment of the shaft 22 regardless of angle at which the shaft 22 is positioned. In addition and by integrating along the circumference at either end of the magnetostrictive material 24, the apparatus 20 is self-correcting or is not susceptible to measurement anomalies associated with shaft 22 wobble or irregularities in the surface of the shaft 22 or magnetostrictive material 24 disposed on the shaft 22.

FIG. 7 is a graphical illustration of a 2^{nd} harmonic component and FIG. 8 is a graphical illustration of a suppressed 2^{nd} harmonic component when the feedback current is produced by the converter 54 and sent into the feedback coil 44. It is important to maintain the fluxgates 32, 36 near saturation, because this causes the 2^{nd} harmonic voltages in the feedback coil 44, as well as DC offset in the excitation coils. Therefore, and in one embodiment, the applied torque is proportional to the feedback current that nullify the 2^{nd} harmonic voltage of the feedback coil 44.

A signal relating to the DC current sent to the feedback coil 44 is also sent to a microprocessor, controller or equivalent means (not shown) having a look up table or other means for determining the applied torque, which is used in any vehicular or other control system requiring torque readings.

In a most preferred embodiment, the first excitation coil 34 comprises 50 turns of 32 gage wire and the second excitation coil 38 comprises 50 turns of 32 gage wire, while the feedback coil 44 comprises 72 turns of 25 gage wire. Of course, and as applications require the gage of the wire and number of turns may vary. In the illustrated embodiment, an AC voltage of 1.8 volts at a 49 frequency of kilohertz is applied to the first and second excitation coils 34, 38. In addition, this voltage is also applied to a frequency doubler 50 that doubles the frequency and applies a 98 kilohertz frequency as a reference input into a lock-in amplifier 52, which is used as a bandpass filter. Accordingly, only voltages at the reference frequency (98 kHz, i.e. double the excitation frequency) will be picked up. Of course, and as applications require the frequency and the magnitude of excitation voltage may vary depending on the design of the flux gate.

The feedback coil 44 voltage is passed through the lock-in amplifier 52 to extract a rectified 2^{nd} harmonic component voltage, which is then inputted into the voltage to current converter 54. This converted voltage is then inputted as DC current in the feedback coil 44 to nullify the saturation caused by the torque flux. The rectified 2^{nd} harmonic component voltage is proportional to the applied shaft 22 torque. FIG. 9 is a graphical illustration of a plot of the 2^{nd} harmonic component voltage on the feedback coil 44 versus an applied torque to the shaft 22.

Obviously, many modifications and variations of the subject invention are possible in light of the above teachings. The invention may be practiced otherwise than as specifically described within the scope of the appended claims.

What is claimed is:

1. A torque sensing apparatus for picking up a magnetic flux flowing from edges of a magnetostrictive material disposed on a shaft, said apparatus comprising:
a first flux collector and a second flux collector spaced from each other and extending annularly around the shaft to define a gap therebetween;
a first fluxgate connected to said first flux collector at one end and to said second flux collector at the other end;
a first excitation coil wound about said first fluxgate; and
a feedback coil positioned in said gap such that said feedback coil is wound within said flux collectors, said first fluxgate, and said excitation coil.

2. An apparatus as set forth in claim 1 further including a second fluxgate connected to said first flux collector at one end and to said second flux collector at the other end.

3. An apparatus as set forth in claim 2 further including a second excitation coil wound about said second fluxgate.

4. An apparatus as set forth in claim 3 wherein said first and second flux collectors, said first and second fluxgates, and said first and second excitation coils are constructed of a high-permeable material.

5. An apparatus as set forth in claim 4 wherein said first and second excitation coils are connected in series.

6. An apparatus as set forth in claim 3 further comprising a detection circuit for determining a torque applied to the shaft.

7. An apparatus as set forth in claim 6 wherein said detection circuit further includes a voltage source for applying a voltage to said first and second excitation coils at a first frequency.

8. An apparatus as set forth in claim 7 wherein said detection circuit further includes a frequency doubler for doubling said first frequency to a second frequency and for producing an output signal relating to the voltage sensed at said second second frequency across said feedback coil.

9. An apparatus as set forth in claim 8 wherein said detection circuit further includes a lock-in amplifier for receiving signals related to a second harmonic voltage waveform on said feedback coil and for receiving a reference signal from said frequency doubler.

10. An apparatus as set forth in claim 9 wherein said detection circuit further includes a voltage to current converter configured to receive said output signal and convert it to a current wherein said current in said feedback loop is driven to balance the flux that is applied to said first fluxgate and said second fluxgate.

11. An apparatus as set forth in claim 3 further including a shield positioned about said first and second flux collectors, said first and second fluxgates, said first and second excitation coils, and said feedback coil to block magnetic interference.

12. An apparatus as set forth in claim 3 wherein said first and second flux collectors, said first and second fluxgates, and said first and second excitation coils are integrally formed as a sleeve unit.

13. An apparatus as set forth in claim 12 wherein said sleeve unit is freely rotatable about the shaft.

14. An apparatus as set forth in claim 3 wherein said first and second flux collectors, said first and second fluxgates, said first and second excitation coils, and said feedback coil are integrally formed as a sleeve unit.

15. A torque sensing apparatus for picking up a magnetic flux, said apparatus comprising:
a shaft;
a magnetostrictive material disposed on said shaft;
a first flux collector and a second flux collector spaced axially from each other along said shaft and extending annularly around said shaft to define a gap between said shaft and said first and second flux collectors;
a first fluxgate connected to said first flux collector at one end and to said second flux collector at the other end;
a first excitation coil wound about said first fluxgate; and
a feedback coil positioned in said gap such that said feedback coil is positioned between said magnetostrictive material disposed on said shaft and said flux collectors, said first fluxgate, and said excitation coil.

16. An apparatus as set forth in claim 15 further including a second fluxgate connected to said first flux collector at one end and to said second flux collector at the other end.

17. An apparatus as set forth in claim 16 further including a second excitation coil wound about said second fluxgate.

18. An apparatus as set forth in claim 17 wherein said first and second flux collectors, said first and second fluxgates, and said first and second excitation coils are constructed of a high-permeable material.

19. An apparatus as set forth in claim 18 wherein said first and second excitation coils are connected in series.

20. An apparatus as set forth in claim 17 further comprising a detection circuit for determining a torque applied to the shaft.

21. An apparatus as set forth in claim 15 wherein said magnetostrictive material is applied by spraying.

22. An apparatus as set forth in claim 15 wherein said magnetostrictive material is applied by thermal spraying.

23. An apparatus as set forth in claim 15 wherein said magnetostrictive material is applied by kinetic spraying.

24. An apparatus as set forth in claim 15 wherein said magnetostrictive material is further defined as including magnetostrictive particles selected from one of iron, iron alloys, ingot rare earth composites, nickel, and terfenol.

25. An apparatus as set forth in claim 24 wherein said magnetostrictive material is further defined as including magnetic particles with coercivity selected from AlNiCo₅ magnets and melt spun terfenol.
